(19) United States
(12) Patent Application Publication
(10) Pub. No.: US 2005/0044050 A1
(43) Pub. Date: Feb. 24, 2005

(54) Techniques for valuing, insuring, and certifying a valuation of landscape architectures

(75) Inventors: C. Thomas Hendrickson, Zebulon, NC (US); William P. Glynn, Cary, NC (US); David J. Argay, Cary, NC (US); Gordon A. Reinert, Boulder, CO (US); Kevin L. Karlin, Highlands Ranch, CO (US); David L. Andrus, Boulder, CO (US)

Correspondence Address: BURNS DOANE SWECKER & MATHIS L L P, POST OFFICE BOX 1404, ALEXANDRIA, VA, 22313-1404, US

(73) Assignee: Horticultural Asset Management, Inc.

(21) Appl. No.: 10/642,865

(22) Filed: Aug. 18, 2003

(51) Int. Cl. G06F 17/60; G06F 17/00

(52) U.S. Cl. 705/400

(57) ABSTRACT

Techniques are described for valuing, insuring, and certifying a valuation of landscape architectures. According to exemplary embodiments, a method for valuing landscape architectures includes identifying a landscape architectural object, and determining a future value associated with the landscape architectural object. The determined future value is based on at least one of a material cost associated with the landscape architectural object and an installation cost associated with an installing of the landscape architectural object in a landscape architectural setting. A growth rate is associated with the landscape architectural object, and a size of the object is determined using the growth rate. The material and installation costs can be determined based on at least one of the determined size, aggregate pricing information, and environmental and economic trends.

### BACKGROUND

Landscape architectures are arrangements of landscape architectural objects (natural and/or structural) in a landscape architectural setting developed for human use and enjoyment. A landscape architecture can include both an aesthetic component, e.g., the arrangement of the landscape architectural objects and/or the setting, and a physical component, e.g., the landscape architectural objects and the setting themselves. Landscape architectures not only greatly contribute to our environment and quality of life, but can add significant value to commercial and residential property.

Each year, billions of dollars are spent on developing landscape architectural settings in the United States for homes, businesses, parks, schools, streets, and the like. Despite knowing the amount of money spent on the landscape architectural objects and setting at the time such improvements are made, there exists no consistent methodology for determining a value of the objects as included in the landscape architectural setting, or a value that the objects and setting add or will add to the improved property. In general, to date, the valuation of landscape architectural objects and settings can be described more as an art rather than a science.

For example, it is estimated that approximately twenty million appraisals are performed annually in the United States in connection with the financing, purchasing, or insuring of real estate. In each of these appraisals, a generally subjective and arbitrary value is typically assigned to the landscape architectural settings associated with the real estate. Rather than driving the overall appraised value of the real estate, as occurs with other real property improvements such as building additions, the value of a landscape architectural setting is typically assessed to be an arbitrary percentage, e.g., seven percent, of a final appraised real estate value.

Other methods of valuing landscape architectures focus on a current cost of the landscape architectural objects included in a particular landscape architectural setting. These methods can overlook an aggregate value contribution of the objects to a landscape architecture, and an appreciation in value that can occur as the objects mature in a landscape architectural setting. As a result, the values assigned to landscape architectural settings are inconsistent and inaccurate, and are thus unreliable.

Without access to standardized value information and methods for determining the value of landscape architectural settings, insurance and financing institutions can have little confidence in the accuracy of the resulting values assigned to landscape architectural objects and settings. As a result, owners of residential and commercial real estate have been unable to realize the full added value gained by investing in their landscape architectural settings.

The establishment of such standards and methods can give insurance and financing institutions the tools needed to consistently value landscape architectural objects and settings in an objective, non-arbitrary manner. Consequently, owners of residential and commercial real estate investing in their landscape architectural settings could receive the full benefit of their investments, such as an ability to fully insure or collateralize their landscape architectural objects and settings.

Consistent and accurate landscape architecture valuation can also lead to an increased awareness among property owners of a need to protect their investment in a landscape architectural setting though development, care, and maintenance programs. This increased awareness can in turn lead to an increased demand for landscape maintenance services, inspections, and other services performed in connection with ensuring the proper development of landscape architectures.

Moreover, knowledge of the value of an investment in landscape development at some time in the future can aid property owners in making more informed decisions regarding the current costs and returns on investment associated with various capital improvement projects.

### SUMMARY

Accordingly, techniques are disclosed for valuing landscape architectures. According to an exemplary embodiment, a method for valuing landscape architectures includes identifying a landscape architectural object, and determining a future value associated with the landscape architectural object. In another exemplary embodiment, the determined future value is based on at least one of a material cost associated with the landscape architectural object and an installation cost associated with an installing of the landscape architectural object in a landscape architectural setting.

According to another exemplary embodiment, a method for providing a landscape architecture valuation report includes determining a future value associated with at least one landscape architectural object as included in a landscape architectural setting. At least one attribute associated with the landscape architectural object is identified. The future value is presented in the report together with the at least one attribute associated with the landscape architectural object.

According to another exemplary embodiment, a method of insuring landscape architectures includes identifying a landscape architectural object. A future value associated with the landscape architectural object is determined based on at least one of a material cost associated with the landscape architectural object and an installation cost associated with an installing of the landscape architectural object in a landscape architectural setting. A risk-of-loss associated with the landscape architectural object is determined, and a premium cost is assigned to the object based on the determined future value and risk-of-loss.

According to another exemplary embodiment, a method for certifying a landscape architecture valuation includes identifying a landscape architectural object. A standard for valuing the landscape architectural object is identified. A future value associated with the landscape architectural object is determined based on at least one of a material cost associated with the landscape architectural object and an installation cost associated with an installing of the landscape architectural object in a landscape architectural setting according to the identified standard for valuing the landscape architectural object. A certified appraisal associated with the landscape architectural object is created based on the determined future value.

According to another exemplary embodiment, a system for valuing landscape architectures includes a data model having information associated with a landscape architectural object. A processor is operatively coupled to the data model, and includes logic configured to determine a future value associated with the landscape architectural object based on at least one of a material cost associated with the landscape architectural object and an installation cost associated with an installing of the landscape architectural object in a landscape architectural setting.

According to another exemplary embodiment, a computer readable medium containing a computer program for valuing landscape architectures includes executable instructions for identifying a landscape architectural object, determining a growth rate associated with the landscape architectural object, determining regional pricing information associated with at least one of the landscape architectural object and the installing of the landscape architectural object in the landscape architectural setting, determining at least one of a material cost associated with the landscape architectural object and an installation cost associated with an installing of the landscape architectural object based on the determined growth rate and regional pricing information, and determining a future value associated with the landscape architectural object based on at least one of the material cost associated with the landscape architectural object and the installation cost associated with an installing of the landscape architectural object.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for valuing landscape architectures according to an exemplary embodiment;

FIG. 2 is a flowchart illustrating a method of providing a landscape architecture valuation report according to an exemplary embodiment;

FIG. 3 is a flowchart illustrating a method for insuring landscape architectures according to an exemplary embodiment;

FIGS. 4-7 illustrate a method for certifying a landscape architecture valuation according to an exemplary embodiment;

FIG. 8 illustrates a system for valuing landscape architectures according to an exemplary embodiment;

FIGS. 9A-9C illustrate an exemplary data model used in conjunction with the system for valuing landscape architectures shown in FIG. 8;

FIG. 10 illustrates a landscape architectural object valuation report according to an exemplary embodiment;

FIG. 11 illustrates a landscape architecture appraisal report according to an exemplary embodiment; and

FIG. 12 illustrates a landscape architecture inspection report according to an exemplary embodiment.

### DETAILED DESCRIPTION

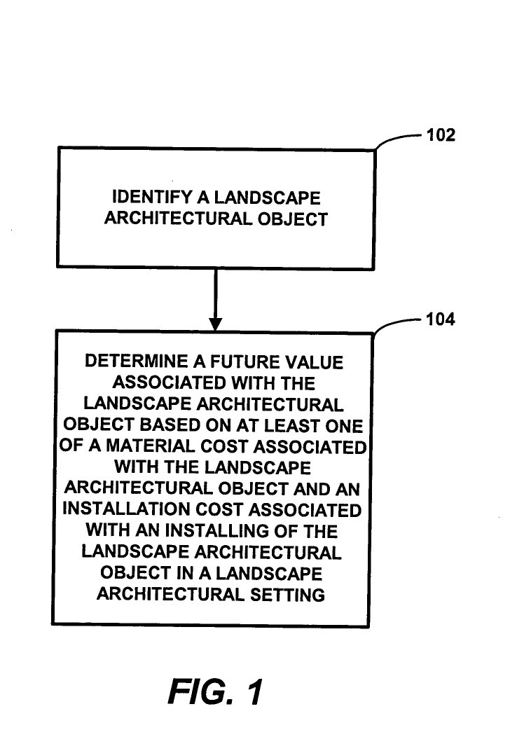

FIG. 1 is a flowchart illustrating a method for valuing landscape architectures according to a first embodiment. In block 102, a landscape architectural object is identified. As used here, a “landscape architectural object” can broadly include both natural and structural objects. Examples of natural objects can include earth, rock, water, and plantings. Water objects can include ponds, waterfalls, streams, marshes, and the like. “Plantings” can include any of a kingdom of living things typically lacking locomotive movement or obvious nervous or sensory organs and possessing cellulose cell walls. Examples of plantings can include trees, lawns, and plants.

Structural landscape architectural objects can include earth-related structures, such as berms, mounds, slopes, swells, earthen-planters, earthen-retaining walls, dry creek beds, and the like. Other structural objects can include enclosure structures, such as fences and walls, shelter structures, such as a gazebo, garden houses, and pagodas, and other specialty buildings, such as arbors and pergolas. Other landscape architectural objects can include engineering structures, such as vehicular and pedestrian ways, decks, patios, pools, fountains, retaining walls, planters, and the like. Other structural objects can include engineering systems such as irrigation systems, lighting systems, and garden railroad systems. Structural landscape architectural objects can also include sculptural components, such as statues, sculptures, ornaments, and the like. Additional examples of structural objects can include outdoor furnishings, such as benches, gliders, and swings.

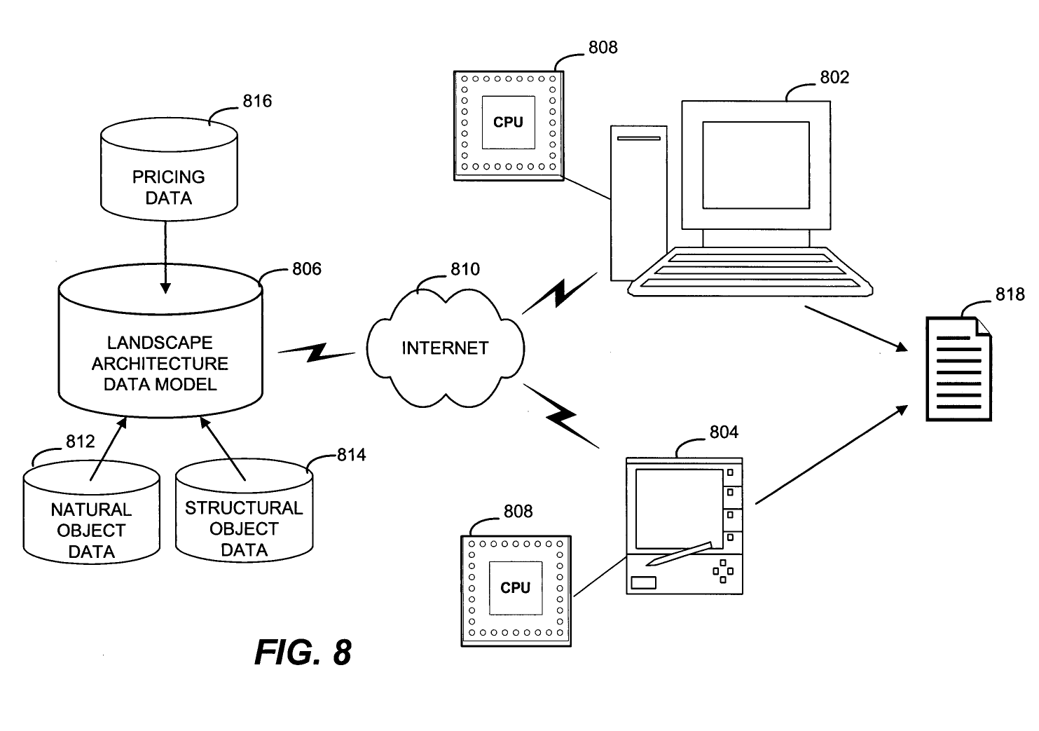

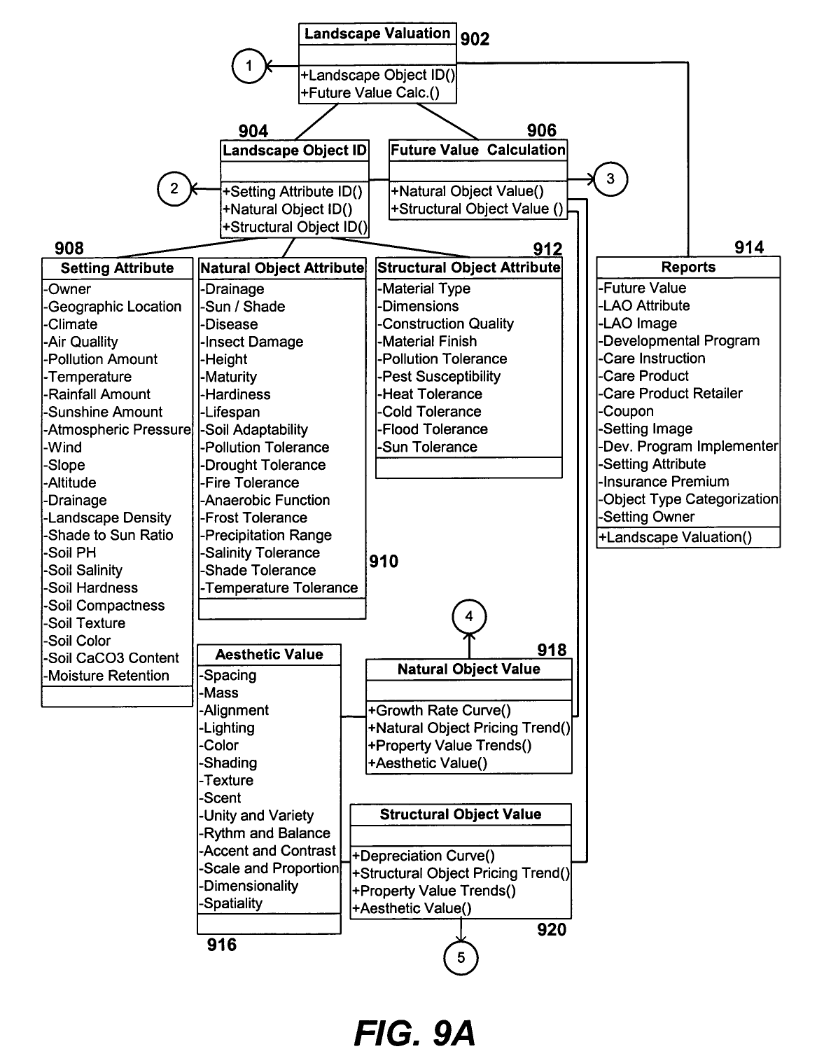

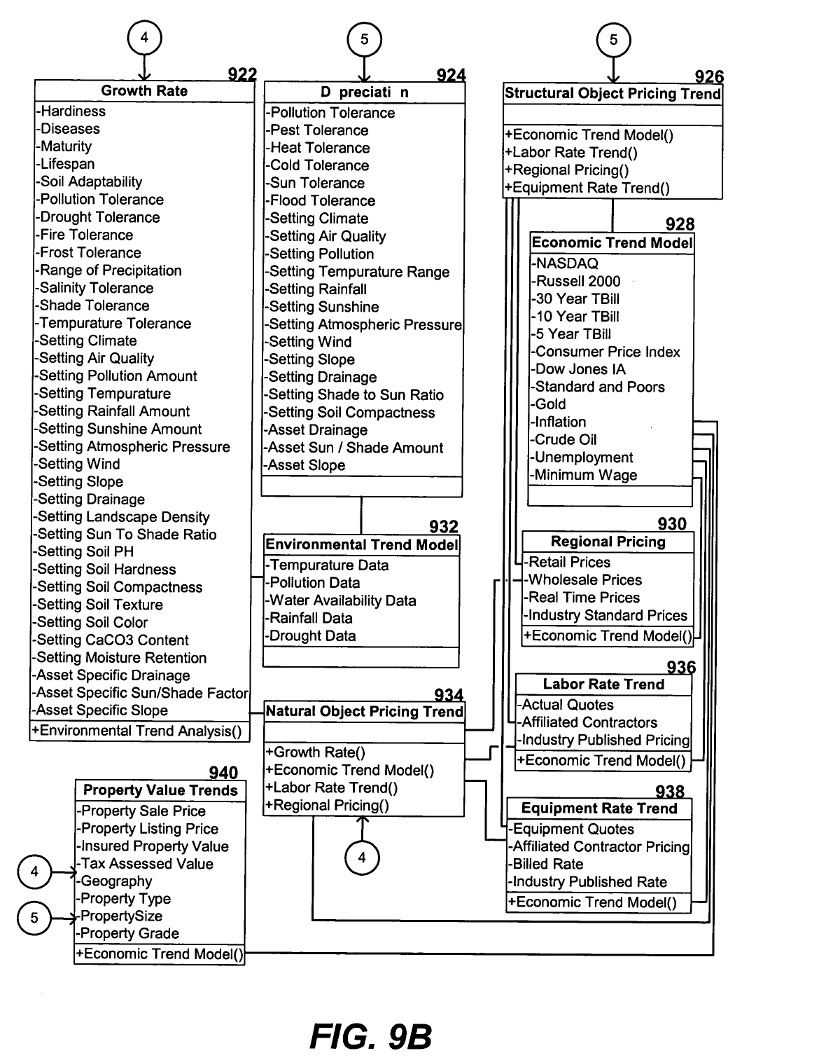

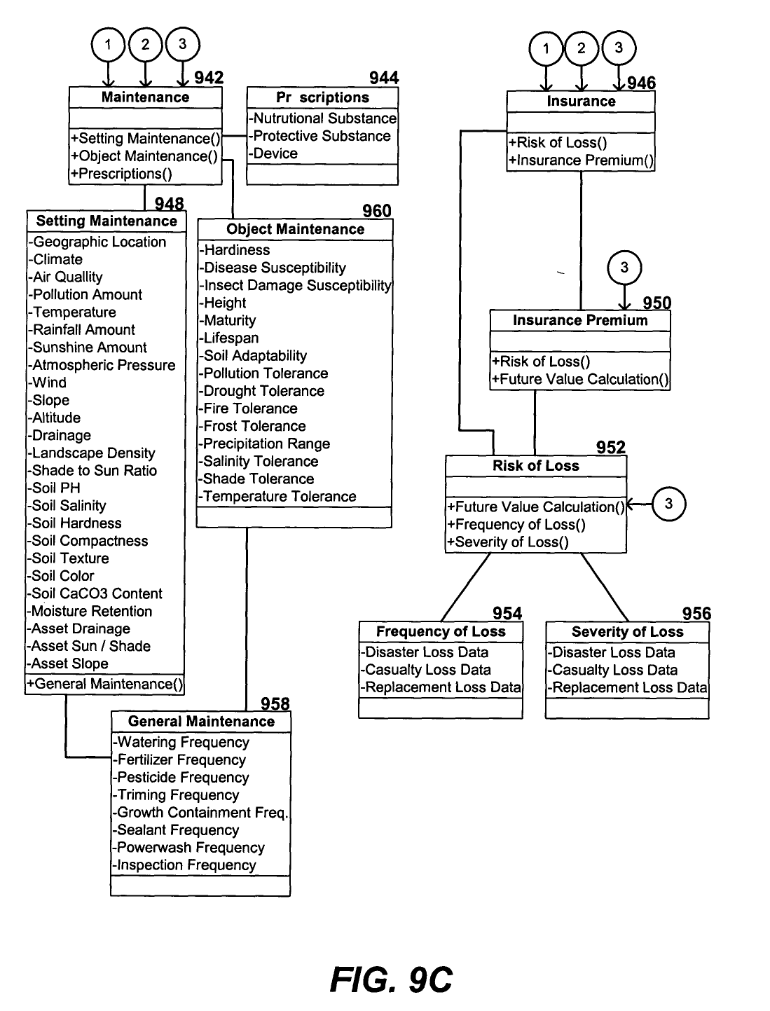

The landscape architectural object can be identified from a database including information describing the landscape architectural object and its associated attributes. For example, in the exemplary landscape architecture valuation system shown in FIG. 8, an object-oriented landscape architecture data model 806 can include a number of data objects describing attributes and methods associated with the identification of the landscape architectural object. For example, the data objects 910, 912 shown in FIG. 9A can include attributes associated with natural and structural landscape architectural objects. These attributes can be gathered periodically from inventory databases, such as the natural object 812 and structural object 814 databases shown in FIG. 8, and then stored in the data model 806 for use in conjunction with the landscape architecture valuation system.

Identification of the landscape architectural object can occur via an input/output (I/O) device, such as a workstation 802 or a personal data assistant (PDA) 804, included in the system shown in FIG. 8. The I/O device can be operatively coupled to the data model 806 via a network 810, such as the Internet. Alternatively, the data model can be stored in memory included in or directly coupled to the I/O device. An inspector, appraiser, or designer can access information included in the data model 806 using the I/O device 802, 804 when inspecting, appraising, or designing a landscape architecture.

A processor 808 is included in the system, and can be configured to execute the instructions of a computer program for valuing landscape architectures. The processor 808 can be operatively coupled to the I/O device 802, 804 for exchanging information with a user, and is configured to exchange and use information included in the data model 806. The computer program can be configured to present a graphical user interface (GUI) (not shown) on a display portion of the I/O device 802, 804. The GUI can be configured to present information to identify the landscape architectural object from information stored in the data model 806. A user can identify the landscape architectural object via the GUI by selecting the object, e.g., from a drop-down list or from a table, using an input selection device, such as a mouse, keyboard, tablet pen, and the like.

In block 104 of the method, a future value associated with the identified landscape architectural object is determined based on at least one of a material cost associated with the landscape architectural object and an installation cost associated with an installing of the landscape architectural object in a landscape architectural setting. As used here, a future value can mean any value associated with the landscape architectural object at a time subsequent to the identification of the landscape architectural object.

For example, at the time the landscape architectural object is identified using the I/O device 802, 804, the object has a particular current value, e.g. a current material cost associated with the object. After identification, however, the landscape architectural object's value can be affected by many factors, including but not limited to growth, depreciation, an added value derived from an installing of the landscape architectural object, e.g., an installation labor cost, and an added value derived from the object's contribution to a landscape architectural setting, e.g., an aesthetic value.

The future value can be determined using the landscape valuation system shown in FIG. 8. The computer program discussed above can be further configured to determine the future value using information included in the data model 806. The determination is based on at least one of a material cost associated with the landscape architectural object, and an installation cost associated with the installing of the object in the landscape architectural setting. The determination is made based on at least one of these costs at some future time after identification of the object. To determine the future value, the computer program can include instructions for determining, among other things, a growth rate, a depreciation rate, a material cost, an installation cost, an environmental trend, a macro-economic trend, a developmental value, a maintenance value, a care value, a property value, a property value trend, and an aesthetic value associated with the landscape architectural object.

For example, according to an exemplary embodiment, the material cost can be based on a growth rate associated with the landscape architectural object. The growth rate can be determined based on an attribute of the landscape architectural object. Generally, a growth rate can be associated with a natural object. The attributes associated with the landscape architectural object that can affect growth rate can include, among other things, a hardiness, a disease susceptibility, an insect damage susceptibility, a height, a maturity, a spread, a basal width, a container size, a lifespan, a soil adaptability, an anaerobic capacity, a pollution tolerance, a drought tolerance, a fire tolerance, a frost tolerance, a precipitation range, a salinity tolerance, a shade tolerance, a drainage capacity, a shade-to-sun capacity, and a temperature tolerance.

The lifespan associated with a natural landscape architectural object can be determined using an actuarial model configured to characterize and predict the life expectancy of the planting using statistical methods and data. The actuarial model can determine probabilities associated with the life expectancy of the natural object and integrate those probabilities with information regarding costs and rates of return to aid in determining the future value of the landscape architectural object.

Attributes of the landscape architectural object can be gathered and updated periodically from databases such as the natural object 812 inventory database shown in FIG. 8. The gathered information can then be included in the data model 806 as attributes included in the natural object 910 and growth rate 922 data objects shown in FIGS. 9A and 9B, respectively.

According to another exemplary embodiment, the growth rate can be based on an attribute of the landscape architectural setting. For example, the growth rate can be based on a geographic location, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a calcium carbonate (CaCO₃) content, and a moisture retention factor associated with the landscape architectural setting.

Attributes of the landscape architectural setting can be general setting attributes, e.g., associated with a geographic zone or climate region where the setting is located, or can be site-specific attributes associated with a particular geographic location. General setting attributes can be gathered and updated periodically from databases (not shown) and incorporated in the data model 806. Site-specific setting attributes can be gathered by a landscape inspector, entered into the I/O device 802, 804, and then included into the data model 806. The gathered information can be includes as attributes in the setting data object 908 shown in FIG. 9A and the growth rate data object 922 shown in FIG. 9B.

The growth rate can also be determined based on attributes of both the landscape architectural object and the landscape architectural setting. For example, the computer program can be configured to determine a growth rate of the landscape architectural object based on any of the attributes described above. The computer program can use methods and attributes included in the data model 806 to determine the growth rate. The methods and attributes can be encapsulated in data objects, such as the data objects 904, 908, and 910 shown in FIG. 9A, and the growth rate data object 922 shown in FIG. 9B.

According to another exemplary embodiment, the growth rate can be based on an environmental trend model. The environmental trend model can be based on trends of at least one of temperature data, pollution data, water availability data, rainfall data, and drought data associated with the landscape architectural setting. For example, although the attributes of the setting can be gathered and stored in the data model 806 as described above, these attributes can change over time as a result of long-term environmental conditions, such as global warming, El Niño, La Niña, and the like.

Environmental trend information can be gathered, and then methods and attributes added to the data model 806 to adjust not only the growth rate of natural objects, but can be used to adjust the depreciation rate of structural objects as well. For example, referring to FIG. 9B, an environmental trend data object 932 can be linked to both the growth rate data object 922 and to a depreciation data object 924, as shown in the figure.

When the growth rate for a landscape architectural object is determined, a corresponding growth curve for the object can be determined. A size of the landscape architectural object at some future data can be determined based on the determined growth rate and corresponding growth curve for the object. A material cost associated with the landscape architectural object at the future date can then be determined based on the determined size of the object. For example, suppose a crape myrtle tree has one gallon container size at the time of identification. Based on the determined growth rate and corresponding growth curve, a determination can be made that the tree can have a container size of three gallons in five years. A material cost can then be determined for a three gallon crape myrtle to determine the future value of the landscape architectural object.

According to another exemplary embodiment, the material cost can be based on a depreciation rate associated with the landscape architectural object. As growth rate is generally associated with natural objects, depreciation rate is generally associated with structural landscape architectural objects. The depreciation rate can be based on an attribute of the landscape architectural object including a material type, a construction quality, a dimension, and a material finish of the identified object. For example, the material type, construction quality, and material finish of the object can affect the rate of deterioration of the object, and consequently can affect the rate at which the object will depreciate. The dimensions of a structural object can also affect the depreciation rate, much like the property values of dwellings having different square footage can depreciate at different rates.

Attributes of the landscape architectural object can be gathered and updated periodically from databases such as the structural object 814 inventory database shown in FIG. 8. The gathered information can then be included in the data model 806 as attributes included in the structural object 912 and depreciation rate 924 data objects shown in FIGS. 9A and 9B, respectively.

The depreciation rate can also be based on an attribute of the landscape architectural setting. The attributes of the landscape architectural setting that can affect depreciation rate can include, among other things, a geographic location, a climate, an air quality, a pollution amount, a temperature, a rainfall amount, a sunshine amount, an atmospheric pressure, a wind amount, a slope, an altitude, a drainage, a shade-to-sun ratio, and a soil compactness of the setting. Setting attributes can again be general setting attributes or site-specific attributes. These attributes can be gathered and included in the data model 806 in data objects, such as the setting data object 908 shown in FIG. 9A.

The depreciation rate can also be determined based on attributes of both the landscape architectural object and the landscape architectural setting. For example, the computer program discussed above can be configured to determine a depreciation rate of the landscape architectural object based on any of the attributes described above. The computer program can use methods and attributes included in the data model 806 to determine the depreciation rate, such as the data objects 904, 908, and 912 shown in FIG. 9A, and the depreciation rate data object 924 shown in FIG. 9B.

In addition to growth rate and depreciation rate, the future value of the landscape architectural object can also be based on a future cost associated with object, and a future cost associated with the installing of the object in the landscape architectural setting. In this context, the future value can be considered a replacement cost associated with the landscape architectural object, although the object need not be replaced for the future value to be of use for other purposes. For example, as briefly mentioned above and described in detail below, the future value can be used as a basis for insuring, lending against, and otherwise collateralizing the landscape architectural object.

According to an exemplary embodiment, the future value can be based on an industry standard pricing model. The industry standard pricing model can include information relating to a material cost of the landscape architectural object, and an installation cost associated with the installing of the landscape architectural object in the landscape architectural setting. The installation cost can include both a cost for labor, and a cost for equipment need to install the landscape architectural object in the landscape architectural setting. The labor cost information can include, among other things, labor contracting quotes from industry publications and affiliated labor contractors associated with the installing of the landscape architectural object in the landscape architectural setting. Affiliated labor contractors can include a group of labor contractors certified to install landscape architectures according to the techniques described here.

The industry standard pricing model can also include information describing a time and a cost per unit of time associated with the installing of the landscape architectural object in the landscape architectural setting. Such information is analogous to the labor times and labor rates published in association with the repair of automobiles.

According to an alternative exemplary embodiment, the future value can be determined based on regional pricing information associated with the landscape architectural object and the installing of the landscape architectural object in the landscape architectural setting. Again, the regional pricing information can include information relating to a material cost of the landscape architectural object, and an installation cost associated with the installing of the landscape architectural object in the landscape architectural setting. The installation cost can include both a cost for labor, and a cost for equipment need to install the landscape architectural object in the landscape architectural setting. The pricing information can be grouped into regions, such as the Western, Central, and Eastern parts of the United States, but it will be understood that the pricing information can be grouped into any suitable geographic region. The regional pricing information can be included in the data model in a regional pricing data object 930 as shown in FIG. 9B.

The regional pricing information can include combined or aggregated pricing information associated with at least one zip code in the region. In addition, the regional pricing information can be updated periodically based on current regional pricing information associated with the landscape architectural object and the installing of the landscape architectural object in the landscape architectural setting. The regional pricing information can be updated from regional and national pricing databases such as the pricing database 816 shown in FIG. 8. This real-time pricing information can be included in the regional pricing data object 930 of the data model 806, and can be accessible to users of the system for valuing landscape architectures shown in FIG. 8 via the I/O device 802, 804.

The regional pricing information can be based on retail, wholesale, or both retail and wholesale regional pricing information associated with the landscape architectural object and the installing of the landscape architectural object in the landscape architectural setting. Wholesale pricing information can be used to exclude or de-emphasize artificially inflated retail regional pricing included in the data model 806. For example, when aggregated pricing information associated with at least one zip code, it can be necessary to account for artificially inflated retail pricing in zip code regions that have only a small number of retail outlets for landscape architectural objects. Wholesale regional pricing information can be used to identify these artificially inflated retail prices, and exclude them from the data model 806. The retail and wholesale regional price information can be included the regional pricing data object 930 shown in FIG. 9B.

As with the industry pricing model described above, the regional pricing information can include labor costs associated with the installing of the landscape architectural object in the landscape architectural setting. These labor costs can include labor contracting quotes from industry publications and affiliated labor contractors. The regional pricing information can also include information describing a time and a cost per unit of time associated with the installing of the landscape architectural object in the landscape architectural setting.

According to an exemplary embodiment, a macro-economic trend model can be used to determine the future value associated with the landscape architectural object. The macro-economic trend model can be based on “NASDAQ” data, “RUSSELL 2000” data, thirty-year treasury bill data, consumer price index data, “DOW JONES” industrial average data, “STANDARD AND POOR'S” data, gold pricing data, five-year treasury bill data, inflation data, crude oil pricing data, unemployment data, federal reserve data, ten-year treasury bill data, and minimum wage data. Methods and variables related to the macro-economic trend model can be included in the data model 806 via an economic trend model data object 928 as shown in FIG. 9B.

The macro-economic trend model can be used to predict an increase in both the material cost associated with the landscape architectural object and the installation cost associated with the installing of the landscape architectural object in the landscape architectural setting due to inflation and other economic factors. For example, it was described above that a determination can be made that a crape myrtle having a one gallon container size at the time of identification can have a container size of three gallons in five years based on a determined growth rate and associated growth curve. A current material and installation cost associated with a three gallon crape myrtle can be determined based on regional and/or industry standard pricing as described above. The macro-economic trend model can be used to adjust the current material cost and installation cost associated with a three gallon crape myrtle to obtain a value of the three gallon crape myrtle five years in the future.

As can be expected, the macro-economic trend model can influence a number of variables used in determining the future value of the landscape architectural object. This influence can be incorporated into the data model 806 by providing links in the data model 806 between the economic trend model data object 928 and other related data objects in the model 806. For example, in FIG. 9B links are indicated between the economic trend model data object 928 and data objects related to regional pricing 930, labor rate trends 936, equipment rate trends 938, natural object pricing trends 934, structural object pricing trends 926, and property value trends 940.

According to another exemplary embodiment, the future value associated with the landscape architectural object can be based on a property value trend model associated with the landscape architectural setting. The property value trend model can include, among other things, information related to a property sale price, an advertised property price, an insured property value, a property type, e.g., commercial or residential, a property grade associated with the condition of the property, a lot size or property acreage, a structure size or property square footage, and a property tax assessment value associated with the landscape architectural setting. Methods and variables related to the property value trend model can be included in the data model 806 via a property value trend data object 940 as shown in FIG. 9B. The property value trend data object 940 can be linked to other objects in the data model 806 related to economic trends 928, natural object pricing trends 934, and structural object pricing trends 926.

The future value associated with the landscape architectural object can also be influenced through appropriate development, maintenance, and care of the landscape architectural object and landscape architectural setting. Such development, maintenance, and care can result in an increased growth rate associated with natural objects, and a decreased depreciation rate associated with structural objects. This, in turn, can lead to an increased future value associated with the landscape architectural object.

A developmental program can be designed to address, among other things, a hardiness, a disease susceptibility, an insect damage susceptibility, a height, a maturity, a spread, a basal width, a container size, a lifespan, a soil adaptability, a pollution tolerance, a drought tolerance, a fire tolerance, a frost tolerance, a precipitation range, a salinity tolerance, a shade tolerance, and a temperature tolerance associated with the landscape architectural object.

In addition to object attributes, the developmental program can be designed to address general setting attributes, e.g., attributes based on a geographic zone or climate region associated with the setting, or can address site-specific setting attributes associated with a particular geographic location of the landscape architectural setting.

Among the setting attributes the developmental program can address are a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a CaCO₃ content, a moisture retention factor, and associated with the landscape architectural setting.

A maintenance program can be designed to define a recommended frequency of watering, fertilizing, pesticide application, trimming, growth containment, sealing, painting, cleaning or power-washing, and inspecting the landscape architectural objects and setting. Such maintenance can aid in increasing the future value associated with the landscape architectural object.

According to an exemplary embodiment, an abnormality in the landscape architectural object can be identified, and at least one of a care instruction and a care product can be prescribed to address the abnormality. The identification of the abnormality can occur at a time when the property is being inspected or appraised by a certified professional. As used here, a “certified” professional is an individual trained and tested in the techniques of valuing landscape architectures described here.

Alternatively, well known or common abnormalities can be identified and care instructions and/or care products recommended at the time a landscape architecture is being designed. The prescribed care instruction and care product can be included in the developmental program. Following the prescribed care instructions can result in an increased future value associated with the landscape architectural object.

Development, maintenance, and care information can be included in the data model 806 For example, developmental requirements associated with a landscape architectural setting can be included in a setting maintenance requirement data object 948, developmental requirements associated with a landscape architectural object can be included in an object maintenance requirement data object 960, and general maintenance requirements can be included in a general maintenance requirements data object 958, as shown in FIG. 9C. Care instructions and prescription care products can be included in a prescription data object 944 as indicated in the figure. Links can be included in the data model, linking the development, maintenance, and care data objects to the data object for determining the future value 906 of the landscape architectural object.

The future value associated with the landscape architectural object can be adjusted based on a value of property associated with the landscape architectural object, or a total future value associated with a plurality of landscape architectural objects as included in the landscape architectural setting. For example, consider an example where the total future value of all landscape architectural objects included in a landscape architectural setting exceeds thirty percent of the total appraised property value including the objects, setting, and a dwelling included on the setting. Under such circumstances, it can be necessary to adjust future value of particular landscape architectural objects or the aggregate total future value of the objects to account for the relatively low total appraised property value.

In addition to the above, the future value associated with the landscape architectural object can adjusted based on a total future value associated with a plurality of landscape architectural objects of a same object category as included in the landscape architectural setting. For example, consider in the example given above that a future value associated with a pool is determined to be twenty percent of the total appraised property value. Under these circumstances, the future value of the pool can be adjusted (or reduced) to bring the total future value of the landscape architectural objects included in the setting in line with the total appraised property value.

In addition to material and installation costs, the future value of the landscape architectural object can be influenced by aesthetic considerations. Accordingly, in another exemplary embodiment, a value associated with the landscape architectural object can be determined based on an aesthetic contribution of the object to the landscape architectural setting. The aesthetic contribution can be associated with the object and can include, among other things, a spacing, a mass, an alignment, a color, a lighting, a shading, a texture, and a scent of the object. The aesthetic contribution can also provide a thematic element to the landscape architectural setting, such as providing a unity and variety, a rhythm and balance, an accent and contrast, a scale and proportion, a dimensionality, and a spatiality to the setting.

The various aesthetic factors influencing the future value of the landscape architectural object can be included in the data model 806. For example, an aesthetic value data object 916 can be included in the data model as shown in FIG. 9B. The aesthetic value data object 916 can be linked to both the natural object value 918 and structural object value 920 data objects as shown in the figure to influence the overall future value determination associated with the landscape architectural object.

The future value associated with the landscape architectural object can be associated with at least one of an implementation, a scheme, a plan, and a design of the landscape architectural setting. That is, a future value of a landscape architectural object can be determined at a time when a landscape architecture is first being designed. In such situations, a landscape designer (preferably, but necessarily certified) can access the data model 806 via the I/O device to identify one or more landscape architectural objects. The computer program described above can determine a future value associated with the landscape architectural objects based on methods and information included in the data model.

Alternatively, the future value associated with the landscape architectural object can be determined as included in existing landscape architectural setting. A typical example when this can occur is when the landscape architectural object is either being inspected or appraised in conjunction with the sale of property associated with the landscape architectural setting. In such situation, an inspector or appraiser (again, preferably, but not necessarily certified) can access information included in the data model 806 using the I/O device 802, 804 when performing the inspection or appraisal to determine the desired future value of the landscape architectural object.

In a related exemplary embodiment, a present value of the landscape architectural object can be determined based on the determined future value of the object. The present value can be used in conjunction with lending practices, such as obtaining an annuity based on the determined present value, or the present value can be used in foreclosure proceedings against property associated with the landscape architectural object.

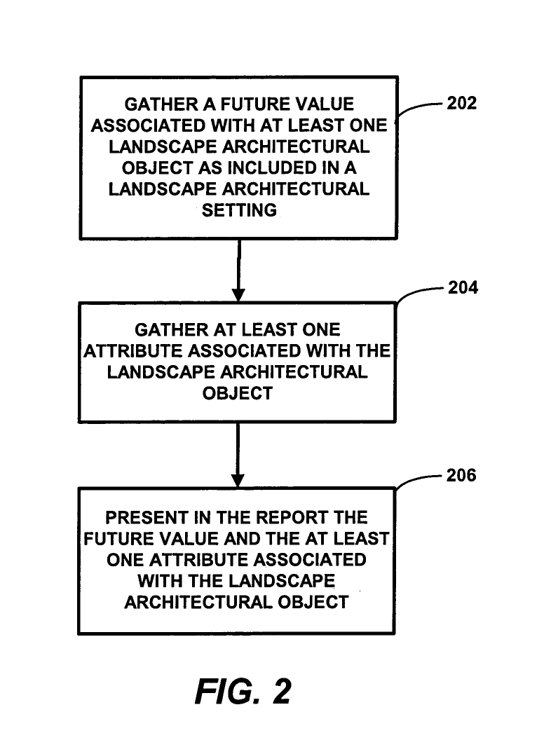

FIG. 2 illustrates a method for providing a landscape valuation report according to an exemplary embodiment. In block 202, a future value associated with at least one landscape architectural object as included in a landscape architectural setting is determined. The future value can be determined as described above in conjunction with exemplary method shown in FIG. 1. The exemplary system for valuing landscape architectures shown in FIG. 8 can be used to determine the future as described above. Alternatively, the future value can be stored in memory (not shown), and then gathered from the memory in block 202 in providing the report.

In addition to the future value, at least one attribute associated with the landscape architectural object is identified in block 204 of the method. The attribute can be included in the data model 806, and more particular can be included in the natural object attribute 910 and structural object attribute 912 data objects shown in FIG. 9A. The attribute can include any of the object attributes described above or shown in the figure.

In block 206 of the method, the future value is presented in the report together with the at least one attribute associated with the landscape architectural object. For example, the computer program described above can include program instructions for generating the report 818. Methods and variable information can be included in the data model 806 for generating the report, such as the report data object 914 shown in FIG. 9A. The report can be presented on a display portion of the I/O device 802, 804, and can be printed or stored for future reference.

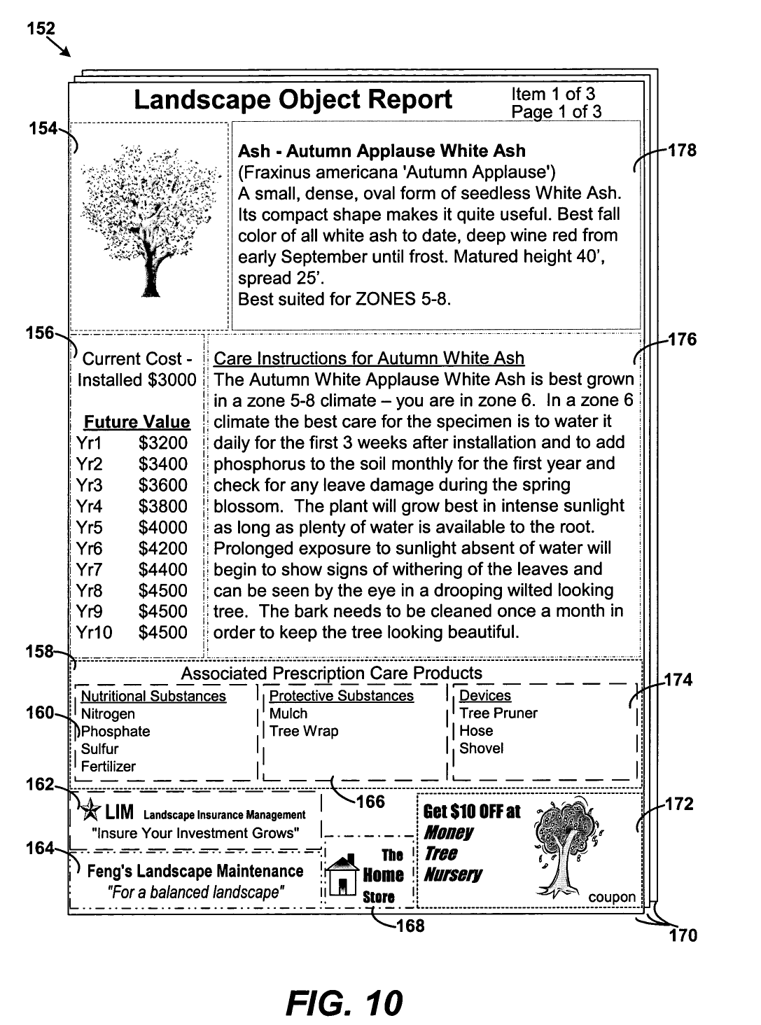

The future value and the at least one attribute associated the landscape architectural object can be presented in any number of arrangements or formats. For example, the future value can be presented in a value curve 156 as shown in the arrangement of FIG. 10, and the at least one attribute of the landscape architectural object can be presented in an object description portion 178 of the report as shown in the same figure.

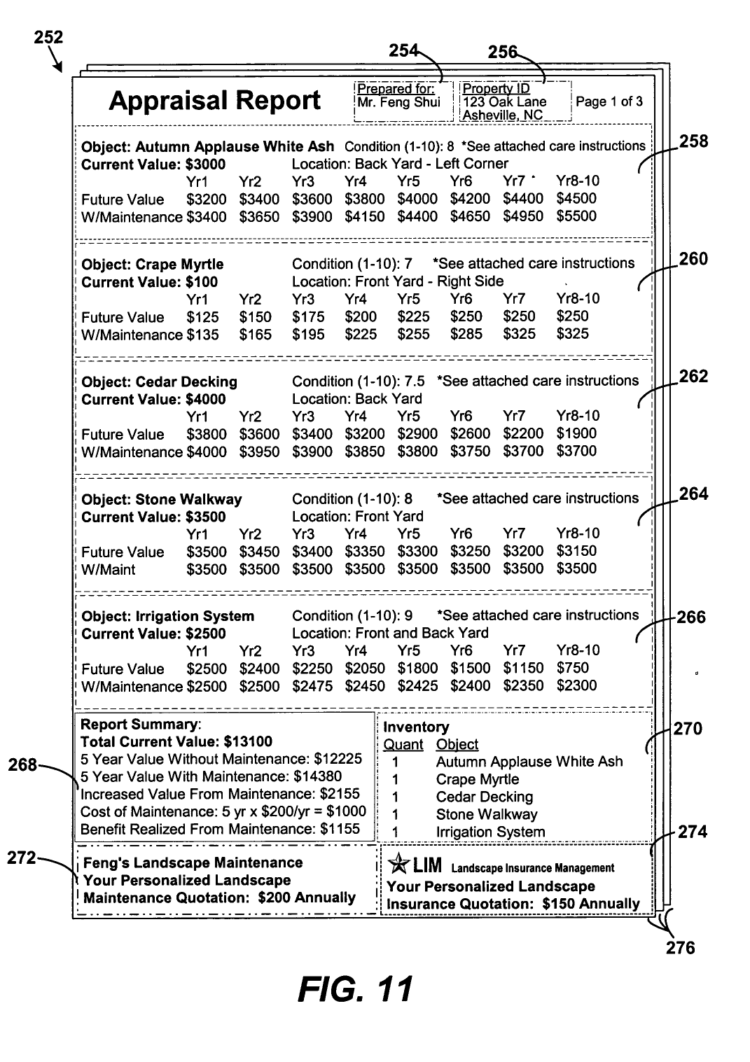

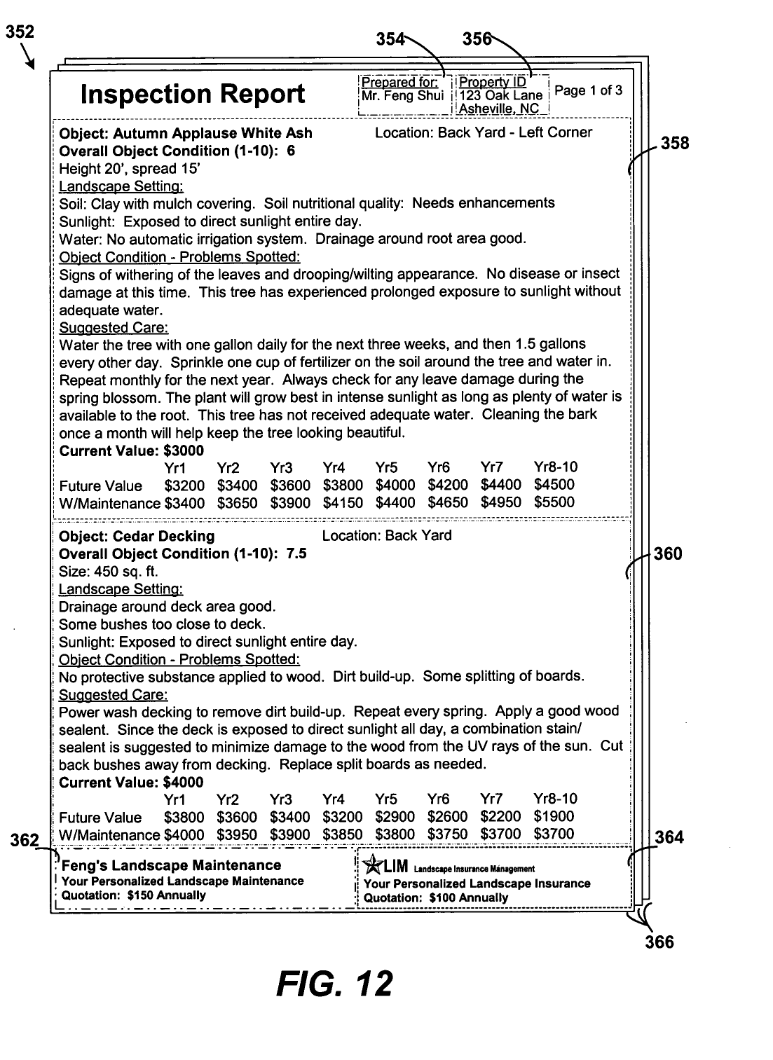

Three exemplary report arrangements are provided in FIGS. 10-12. The arrangement shown in FIG. 10 is referred to as a landscape object report 152, and can be provided to a user during the design or planning stage of developing a landscape architecture. The arrangement shown in FIG. 11 is referred to as an appraisal report 252, and can be provided to a user at a time when the landscape architectural setting and the objects included therein are being appraised (preferably, but not necessarily by a certified appraiser) in conjunction with the sale of property associated with the landscape architectural setting. The third arrangement shown in FIG. 12 is referred to as an inspection report 352, and can again be provided to a user when the property is being inspected (preferably, but not necessarily by a certified inspector) in conjunction with the sale of property. The report can be one or more pages 170, as shown in the figures.

According to an exemplary embodiment, a developmental program including at least one of a care instruction and a prescription care product associated with a development of each landscape architectural object can be presented in the report. For example, landscape object report 152 of FIG. 10 includes care instructions 176 for an autumn white ash. The care instruction can be a generalized instruction associated with a particular geographic zone or climate region associated with the landscape architectural setting, or can be a site-specific care instruction associated the particular setting in which the landscape architectural object is or will be installed.

The prescription care product can include, among other things, a nutritional substance, a protective substance, and a device associated with the development of the landscape architectural object. For example, the landscape object report 152 of FIG. 10 includes associated prescription care products 158 identifying nutritional substances 160, such as a fertilizer, nitrogen, phosphate, and sulfur. The landscape object report 152 also identifies devices 174, such as a pruner, a hose, a shovel, an applicator, a power washer, a lawn mower, structural material, and a spreader. Protective substances 166, such as mulch, a tree wrap, a mildewcide, a stain, paint, a sealer, and a pesticide can also be included in the report.

The care instruction can include, among other things, a prescribed temperature, rainfall amount, sunshine amount, slope, drainage, landscape density, shade-to-sun ratio, soil pH, soil salinity, soil hardness, soil compactness, soil texture, soil color, CaCO₃ content, and maintenance associated with the development of the landscape architectural object.

An identity of a source of the prescription care product can also be included in the report. For example, in the landscape object report 152 of FIG. 10, a product identifier 168 identifies a retail store where the listed prescription care products can be purchased. In addition an identity of an implementer of the developmental program can be included in the report. For example, a landscape maintenance identifier 164 identifies a service provider capable of implementing the development, maintenance, and care programs identified in the report. The identity of the implementer of the developmental program 164 can be determined based on a geographic location of the landscape architectural setting or a location of a user of information included in the report.

According to another exemplary embodiment, a cost associated with the developmental program can be determined, and the determined cost presented in the report. For example, in the appraisal report 252 of FIG. 11, a cost associated with the developmental program can be included in the report together with the identity 272 of the implementer of the program.

In addition to the above, an increase in the future value associated with an implementation of the developmental program can be determined. As described above, the increase in future value can result from both an increase in the growth rate associated with natural objects, and a decrease in the depreciate rate associated with structural objects. The increase in the future value associated with the implementation of the developmental program can be presented in the report. For example, each of the object detail description sections 258-266 included in the appraisal report 252 of FIG. 11 include an increased future value as a result of properly maintaining the object. In addition, a report summary portion 268 of the report includes an aggregate increase in future value as a result of properly maintaining the objects included in the appraisal.

A coupon associated with at least one of the landscape architectural object and the landscape architectural setting can also be presented in the report. For example, landscape object report 152 of FIG. 10 includes a coupon, e.g., for the purchase of products associated with development, maintenance, and care of the landscape architectural object and setting. The report can also include an image 154 of the landscape architectural object, as included in the landscape object report 152.

The attribute associated with the landscape architectural object included in the object description portion 178 of the report can include, among other things, an identity, a geographic location, a climate, a use, an installed cost, a hardiness, an active growth period, a fall conspicuous, a flower color, a flower conspicuous, a foliage color, a foliage porosity summer, a foliage porosity winter, a foliage texture, a fruit/seed color, a fruit/seed conspicuous, a growth form, a growth rate, a height, a maturity, a spread, a basal width, a container size, a leaf retention, a lifespan, a shape, an orientation, a soil adaptability, an anaerobic capacity, a CaCO₃ tolerance, a cold stratification, a drought tolerance, a fire tolerance, a frost tolerance, a hedge tolerance, a moisture use, a PH range, a planting density, a rainfall, a water usage, a root depth, a salinity tolerance, a shade tolerance, a temperature range, a bloom period, and a commercial availability associated with the landscape architectural object.

The identity included as an attribute of the landscape architectural object can include, among other things, a genus, a species, a subspecies, a variety, a form a, a scientific name, a common name, a category, a family, a cultivar, an order, a class and a division associated with the landscape architectural object.

The future value can be based on at least one of a material cost associated with the landscape architectural object and an installation cost associated with an installing of the landscape architectural object in a landscape architectural setting. The material cost and installation cost can be determined as described in conjunction with exemplary method shown in FIG. 1. For example, the value curve 156 included in the landscape object report 152 of FIG. 10 includes entries that represent both a material cost and an installation cost associated with the landscape architectural object. As such, the value curve 158 can be said to represent a replacement cost associated with the landscape architectural object at particular times in the future.

According to an exemplary embodiment, the at least one landscape architectural object can be categorized into an object type, wherein the presenting of the future value and at least one attribute of the landscape architectural object is based on the categorized object type. For example in the landscape object report 152 of FIG. 10, each page 170 in the report can correspond to a particular species or structural object type included or to be included in a landscape architecture. Thus, if a landscape architecture design calls for five autumn white ashes, only one page corresponding to the white ash object type can be included in the report.

In another exemplary embodiment, an inventory of at least one landscape architectural object included in the landscape architectural setting can be gathered, and the inventory presented in the report. For example, in the appraisal report 252 of FIG. 11, an inventory portion 270 of the report can identify an object type and a quantity for all landscape architectural objects included in the landscape architectural setting. The inventory can be presented on one or more pages 276 of the report.

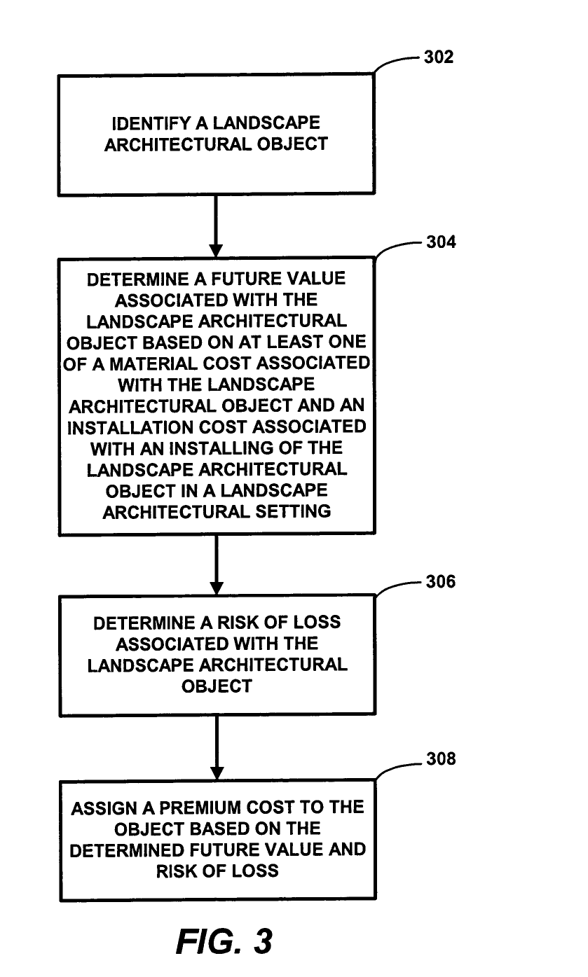

A related exemplary embodiment includes determining insurance premium information based on the future value of the at least one landscape architectural object. A method for insuring landscape architectures and determining an insurance premium is described below in conjunction with exemplary embodiment shown in FIG. 3. The determined insurance premium information can be presented in the report. For example, in the appraisal report 252 of FIG. 11, insurance premium information is included in the report together with an insurance provider identifier 276. The insurance provided can be associated with the geographic location of the landscape architectural setting.

According to an exemplary embodiment, at least one attribute associated with the landscape architectural setting can be identified, and the at least one identified attribute associated with the setting can be presented in the report. For example, in the landscape object report 152, site-specific setting information can be included in the care instructions 176. In addition, in inspection report 352 of FIG. 12, a setting description can be included with each object inspection summary 358, 360. The attributes of the setting can be generalized, e.g., associated with a geographic zone or climate region, site-specific, e.g., associated with a particular geographic location associated with the landscape architectural setting, or object-specific, e.g., as included with each object inspection summary 358, 360 of the inspection report 352.

Attributes of the landscape architectural setting included in the report can include, among other things, a geographic location, a temperature, a rainfall amount, a sunshine amount, a slope, a drainage, a landscape density, a shade-to-sun ratio, a soil pH, a soil salinity, a soil hardness, a soil compactness, a soil texture, a soil color, and a CaCO₃ content.

In another exemplary embodiment, information associated with at least one of a user of information included in the report and an owner of the landscape architectural setting can be gathered. The information associated with the least one of a user and an owner can be presented in the report. For example, the inspection report 352 of FIG. 12 includes a name 354 and an address 356 associated with individual for which the report was prepared.

As described above, the report can be provided in connection with at least one of an implementation, a scheme, a plan, and a design of the landscape architectural setting, as can be the case with the landscape object report 152. In addition, the report can be provided in connection with at least one of an appraisal and an inspection of property associated with the landscape architectural object and the landscape architectural setting. Examples of such reports are the appraisal report 252 of FIG. 11 and inspection report 352 of FIG. 12 described above.

FIG. 3 illustrates a method for insuring landscape architectures according to an exemplary embodiment. In block 302 of the method, a landscape architectural object is identified. As described above, the data model 806 can include data objects 910, 912 as shown in FIG. 9A, which can include attributes associated with natural and structural landscape architectural objects. These attributes can be gathered periodically from inventory databases, such as the natural object 812 and structural object 814 databases shown in FIG. 8, and then stored in the data model 806 for use in conjunction with the landscape architecture valuation system shown in FIG. 8.

In block 304, a future value associated with the landscape architectural object is determined based on at least one of a material cost associated with the landscape architectural object and an installation cost associated with an installing of the landscape architectural object in a landscape architectural setting. The future value can be determined as described above in conjunction with exemplary method shown in FIG. 1. The exemplary system for valuing landscape architectures shown in FIG. 8 can be used to determine the future as described above.

In block 306, a risk-of-loss associated with the landscape architectural object is determined. The risk-of-loss can be based on frequency-of-loss and severity-of-loss information. Both the frequency-of-loss and severity-of-loss information can, in turn, be based on at least one of disaster, casualty, and replacement claim information. Disaster claim information includes claims associated with natural disasters, such as hurricanes, forest fires, and tornados. Casualty claim information includes claims associated with an occurrence not directly related to the loss of the landscape architectural object. For example, a car accident in which a car strikes a tree causing the tree to be damaged or lost can result in a casualty claim for the lost tree. Replacement claim information includes all other causes of loss, such as a loss from disease or theft. Methods and attributes associated with determining the frequency-of-loss and severity-of-loss associated with an object can be encapsulated in the respective data objects 954 and 956 as shown in FIG. 9C.

The risk-of-loss can be determined by first examining the various types of claim information associated with landscape architectural objects, and then determining the probability that a claim against a particular object type will occur. This can be accomplished by examining the frequency-of-loss information and developing an actuarial model to determine the frequency-of-loss of a landscape architectural object. Once the frequency-of-loss is determined, severity-of-loss information can be incorporated into the actuarial model to determine the risk-of-loss associated with the object.

Severity-of-loss information describes the amount of loss that occurs per claim. For example, the amount of loss can be a partial loss or a total loss of the object. Because the payout for landscape architectural objects under property owner insurance plans are typically capped, additional property loss information can be required to accurately factor severity-of-loss information into the actuarial model. Methods and attributes associated with determining a risk-of-loss associated with an object can be encapsulated in the data object 952 as shown in FIG. 9C.

In block 308, a premium cost is assigned to the landscape architectural object based on the determined future value and the risk-of-loss. For example, over a predetermined period of time, a future value of a landscape architectural object, representing a replacement cost of the object, can be determined. The risk-of-loss associated with the landscape architectural object can be determined using an actuarial model as described above. From this information, a premium cost can be assigned to insuring the landscape architectural object against the various types of claims based on the replacement cost that will have to be paid according to the frequency and severity of loss of the object predicted by the actuarial model. Methods and attributes associated with determining the premium cost associated with the object can be encapsulated in the data object 950 as shown in FIG. 9C.

According to an exemplary embodiment, the premium cost can be adjusted based on a value of property associated with the landscape architectural object, or a total future value associated with a plurality of landscape architectural objects as included in the landscape architectural setting. For example, consider an example where the total future value of all landscape architectural objects included in a landscape architectural setting exceeds thirty percent of the total appraised property value including the objects, setting, and a dwelling included on the setting. Under such circumstances, it can be necessary to adjust the premium cost to account for the relatively low total appraised property value.

In addition to the above, in can be necessary to adjust the premium cost based on a total future value associated with a plurality of landscape architectural objects of a same object category as included in the landscape architectural setting. For example, consider in the example given above that a future value associated with a pool is determined to be twenty percent of the total appraised property value. Because the risk-of-loss associated with the pool is likely relatively low, the premium cost can be adjusted accordingly. The premium cost can also be based on a comparison to an industry standard premium cost.

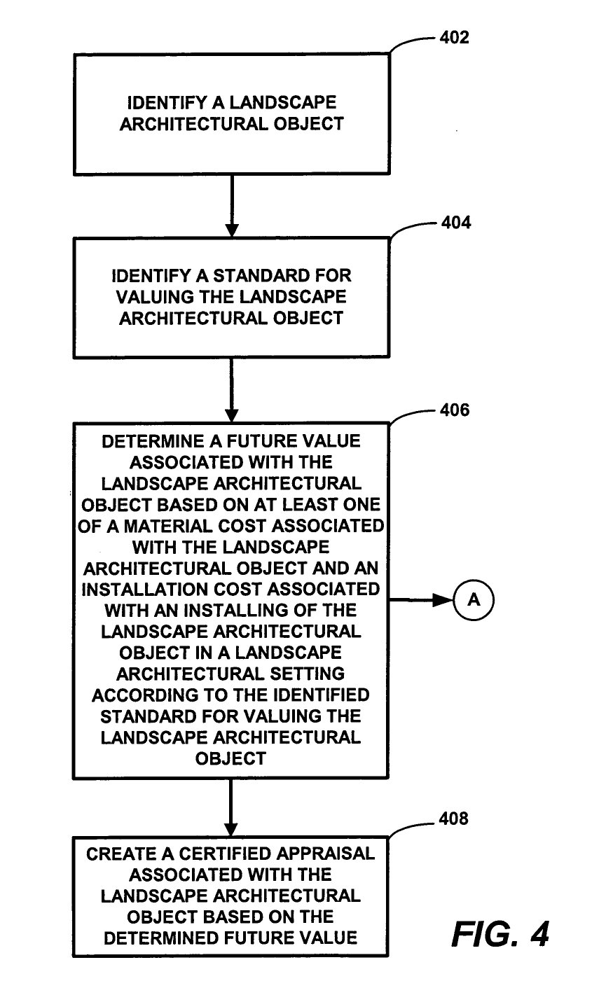

FIGS. 4-7 illustrate a method for certifying a landscape architecture valuation. In block 402, a landscape architectural object is identified. The landscape architectural object can be identified in manner described above in conjunction with exemplary method of FIG. 1. In block 404, a standard for valuing the landscape architectural object is identified. The standard can be based on established business practices of the Associated Landscape Contractors of America (ALCA) and the American Society of Landscape Architects (ASLA), and can incorporate the techniques for valuing landscape architectures described here.

In block 406, a future value associated with the landscape architectural object is determined based on at least one of a material cost associated with the landscape architectural object and an installation cost associated with an installing of the landscape architectural object in a landscape architectural setting according to the identified standard for valuing the landscape architectural object. The future value can be determined as described above in conjunction with the exemplary method of FIG. 1 based on information in harmony with the identified standard for valuing the landscape architectural object. The system for landscape architecture valuation described above in conjunction with FIG. 8 can be used to determine the future value of the landscape architectural object.

In block 408, a certified appraisal associated with the landscape architectural object can be created based on the determined future value. The appraisal can include information such as that included in the exemplary appraisal report 252 shown in FIG. 11.

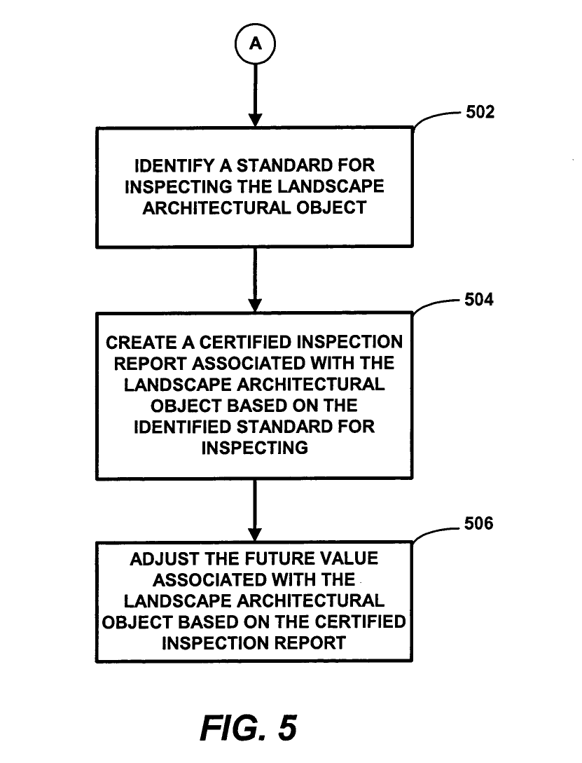

According a related embodiment, a standard for inspecting the landscape architectural object can be identified in block 502 of FIG. 5. Again, the standard for inspecting can be based on the established business practices of the ALCA and the ASLA. In block 504, a certified inspection report associated with the landscape architectural object can be created based on the identified standard for inspecting. The inspection report can include information such as that included in the exemplary inspection report 352 shown in FIG. 12. In block 506, the future value associated with the landscape architectural object can be adjusted based on the certified inspection report.

For example, if the inspection report identifies abnormalities associated with either the landscape architectural object or an associated landscape architectural setting, the future value can be decreased, accordingly. If however, the inspection report identifies appropriate care instructions for addressing the identified abnormalities, a re-adjustment of the future value can occur based on an implementation of care program to address the abnormalities identified in the inspection report.

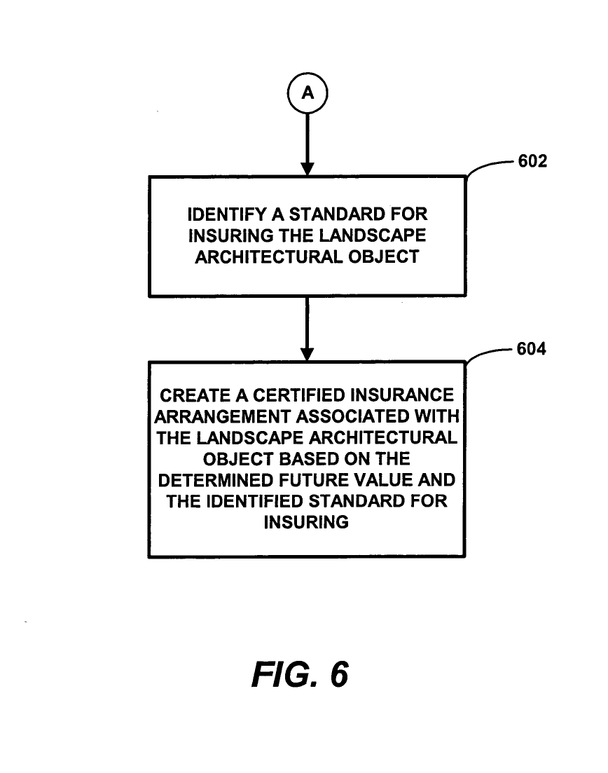

According to yet another related embodiment, a standard for insuring the landscape architectural object can be identified in block 602 of FIG. 6. The standard can be based on an actuarial model as described above. In block 604, a certified insurance arrangement associated with the landscape architectural object can be created based on the determined future value and the identified standard for insuring. The certified insurance arrangement can include a premium cost associated with the landscape architectural object determined as described above in conjunction with the exemplary embodiment shown in FIG. 3.

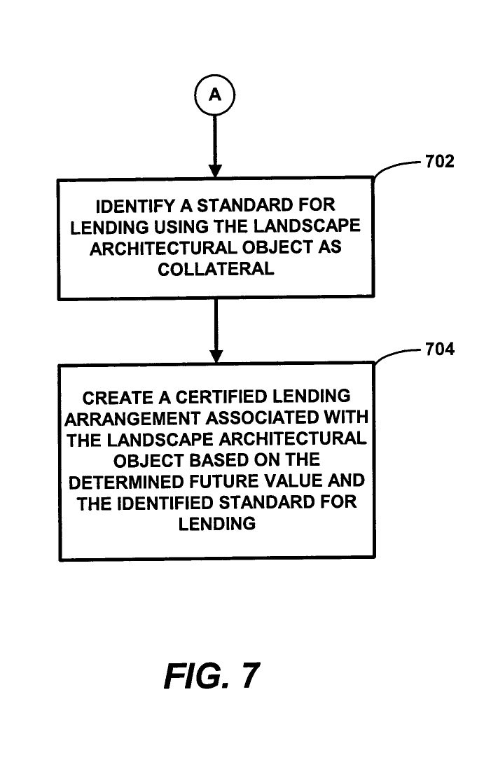

In another related exemplary embodiment, a standard for lending using the landscape architectural object as collateral can be identified in block 702 of FIG. 7. The standard can be based on established business practices for lending against collateralized assets. In block 704, a certified lending arrangement associated with the landscape architectural object can be created based on determined future value and the identified standard for lending. The lending arrangement can be used by owners of landscape architectural objects to secure equity lines of credit and landscape equity loans using the landscape architectural object as collateral for line of credit and loan.

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both.

Thus, the various aspects can be embodied in many different forms, and all such forms are contemplated to be within the scope of what is described. For each of the various aspects, any such form of embodiment can be referred to here as “logic configured to” perform, or “logic that” performs a described action.

A system for valuing landscape architectures according to an exemplary embodiment is shown in FIG. 8. The system includes means for valuing landscape architectures, such as the data model 806 and the processor 808 shown in the figure. The system can include an input/output (I/O) device, such as a workstation 802 or a personal data assistant (PDA) 804, for exchanging with the processor 808 and/or the data model 806. The I/O device can be operatively coupled to the data model 806 via a network 810, such as the Internet. Alternatively, the data model can be stored in memory included in or directly coupled to the I/O device. An inspector, appraiser, or designer can access information included in the data model 806 using the I/O device 802, 804 when inspecting, appraising, or designing a landscape architecture.

The processor 808 can be configured to execute the instructions of a computer program for valuing landscape architectures as illustrated in FIG. 1, and for providing a landscape architecture valuation report as illustrated in FIG. 2. The processor 808 can be operatively coupled to the I/O device 802, 804 for exchanging information with a user, and is configured to exchange and use information included in the data model 806.

The computer program can be configured to present a graphical user interface (GUI) (not shown) on a display portion of the I/O device 802, 804. The GUI can be configured to present information to identify the landscape architectural object from information stored in the data model 806. A user can identify the landscape architectural object via the GUI by selecting the object, e.g., from a drop-down list or from a table, using an input selection device, such as a mouse, keyboard, tablet pen, and the like.

The processor 808 includes logic configured to execute the instructions of the computer program for valuing landscape architectures as illustrated in FIG. 1, and for providing a landscape architecture valuation report as illustrated in FIG. 2 substantially as described above. The data model 806 can include a number of data objects describing attributes and methods associated with valuing landscape architectures and providing a landscape architecture valuation report. The data objects can be configured substantially as described above in conjunction with FIGS. 9A-9C. Attributes included in the data model can be gathered periodically from inventory databases, such as the natural object 812 and structural object 814 databases shown in FIG. 8, and then stored in the data model 806 for use in conjunction with the landscape architecture valuation system.

The instructions of a computer program as illustrated in FIG. 1 for valuing landscape architectures, in FIG. 2 for providing a landscape architectural valuation report, and in FIG. 3 for insuring landscape architectures can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method for valuing landscape architectures, the method comprising:
identifying a landscape architectural object; and
determining a future value associated with the landscape architectural object.

2. A method for valuing landscape architectures, the method comprising:
identifying a landscape architectural object; and
determining a future value associated with the landscape architectural object based on at least one of a material cost associated with the landscape architectural object and an installation cost associated with an installing of the landscape architectural object in a landscape architectural setting.

3. The method of claim 2, wherein the material cost is based on a growth rate associated with the landscape architectural object.

4. The method of claim 3, wherein the growth rate is based on an attribute of the landscape architectural object.

5. The method of claim 4, wherein the attribute of the landscape architectural object includes at least one of a hardiness, a disease susceptibility, an insect damage susceptibility, a height, a maturity, a spread, a basal width, a container size, a lifespan, a soil adaptability, an anaerobic capacity, a pollution tolerance, a drought tolerance, a fire tolerance, a frost tolerance, a precipitation range, a salinity tolerance, a shade tolerance, a drainage capacity, a shade-to-sun capacity, and a temperature tolerance.

6. The method of claim 3, wherein the growth rate is based on an attribute of the landscape architectural setting.

7. The method of claim 6, wherein the attribute of the landscape architectural setting includes at least one of a geographic location, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a calcium carbonate (CaCO₃) content, and a moisture retention factor.

8. The method of claim 3, wherein the growth rate is based on an attribute of the landscape architectural object and an attribute of the landscape architectural setting.

9. The method of claim 8, wherein the attribute of the landscape architectural object includes at least one of a hardiness, a disease susceptibility, an insect damage susceptibility, a height, a maturity, a spread, a basal width, a container size, a lifespan, a soil adaptability, an anaerobic capacity, a pollution tolerance, a drought tolerance, a fire tolerance, a frost tolerance, a precipitation range, a salinity tolerance, a shade tolerance, a drainage capacity, a shade-to-sun capacity, and a temperature tolerance.

10. The method of claim 8, wherein the attribute of the landscape architectural setting includes at least one of a geographic location, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a calcium carbonate (CaCO₃) content, and a moisture retention factor.

11. The method of claim 3, wherein the growth rate is based on an environmental trend model.

12. The method of claim 11, wherein the environmental trend model is based on trends of at least one of temperature data, pollution data, water availability data, rainfall data, and drought data associated with the landscape architectural setting.

13. The method of claim 3, wherein the determining a material cost comprises:
determining a size of the landscape architectural object based on the determined growth rate; and
determining the material cost associated with the landscape architectural object based on the determined size.

14. The method of claim 2, the material cost is based on a depreciation rate associated with the landscape architectural object.

15. The method of claim 14, wherein the depreciation rate is based on an attribute of the landscape architectural object.

16. The method of claim 15, wherein the attribute of the landscape architectural object includes at least one of a material type, a construction quality, a dimension, and a material finish.

17. The method of claim 14, wherein the depreciation rate is based on an attribute of the landscape architectural setting.

18. The method of claim 17, wherein the attribute of the landscape architectural setting includes at least one of a geographic location, a climate, an air quality, a pollution amount, a temperature, a rainfall amount, a sunshine amount, an atmospheric pressure, a wind amount, a slope, an altitude, a drainage, a shade-to-sun ratio, and a soil compactness.

19. The method of claim 14, wherein the depreciation rate is based on an attribute of the landscape architectural object and an attribute of the landscape architectural setting.

20. The method of claim 19, wherein the attribute of the landscape architectural object includes at least one of a material type, a construction quality, a dimension, and a material finish.

21. The method of claim 19, wherein the attribute of the landscape architectural setting includes at least one of a geographic location, a climate, an air quality, a pollution amount, a temperature, a rainfall amount, a sunshine amount, an atmospheric pressure, a wind amount, a slope, an altitude, a drainage, a shade-to-sun ratio, and a soil compactness.

22. The method of claim 2, wherein the future value is based on an industry standard pricing model.

23. The method of claim 22, wherein the industry standard pricing model includes labor contracting quotes from at least one of industry publications and affiliated labor contractors associated with the installing of the landscape architectural object in the landscape architectural setting.

24. The method of claim 22, wherein the industry standard pricing model includes information describing a time and a cost per unit of time associated with the installing of the landscape architectural object in the landscape architectural setting.

25. The method of claim 2, wherein the determining a future value comprises:
determining regional pricing information associated with the landscape architectural object and the installing of the landscape architectural object in the landscape architectural setting.

26. The method of claim 25, wherein the determining regional pricing information comprises:
aggregating pricing information associated with at least one zip code.

27. The method of claim 25, comprising:
updating periodically the regional pricing information based on current regional pricing information associated with the landscape architectural object and the installing of the landscape architectural object in the landscape architectural setting.

28. The method of claim 25, wherein the regional pricing information is based on at least one of retail regional pricing information and wholesale regional pricing information associated with the landscape architectural object and the installing of the landscape architectural object in the landscape architectural setting.

29. The method of claim 28, wherein the retail regional pricing information is based on the wholesale regional pricing information associated with the landscape architectural object and the installing of the landscape architectural object in the landscape architectural setting.

30. The method of claim 25, wherein the retail regional pricing information includes labor contracting quotes from at least one of industry publications and affiliated labor contractors associated with the installing of the landscape architectural object in the landscape architectural setting.

31. The method of claim 25, wherein the retail regional pricing information includes information describing a time and a cost per unit of time associated with the installing of the landscape architectural object in the landscape architectural setting.

32. The method of claim 2, wherein the future value is based on a macro-economic trend model.

33. The method of claim 32, wherein the macro-economic trend model is based on at least one of “NASDAQ” data, “RUSSELL 2000” data, thirty-year treasury bill data, consumer price index data, “DOW JONES” industrial average data, “STANDARD AND POOR'S” data, gold pricing data, five-year treasury bill data, inflation data, crude oil pricing data, unemployment data, federal reserve data, ten-year treasury bill data, and minimum wage data.

34. The method of claim 2, wherein the future value is based on a property value trend model associated with the landscape architectural setting.

35. The method of claim 34, wherein the property value trend model includes at least one of a property sale price, an advertised property price, an insured property value, a property type, a property grade, a lot size, a structure size, and a property tax assessment value associated with the landscape architectural setting.

36. The method of claim 2, wherein the future value is based on a developmental program associated with a development of the landscape architectural object in the landscape architectural setting.

37. The method of claim 36, wherein the developmental program addresses at least one of a hardiness, a disease susceptibility, an insect damage susceptibility, a height, a maturity, a spread, a basal width, a container size, a lifespan, a soil adaptability, a pollution tolerance, a drought tolerance, a fire tolerance, a frost tolerance, a precipitation range, a salinity tolerance, a shade tolerance, a temperature tolerance, and a maintenance of the landscape architectural object.

38. The method of claim 36, wherein the developmental program addresses at least one of a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a calcium carbonate (CaCO₃) content, a moisture retention factor, and a maintenance of the landscape architectural setting.

39. The method of claim 36, comprising:
identifying an abnormality in the landscape architectural object;
prescribing at least one of a care instruction and a care product to address the abnormality; and
including the at least one of the care instruction and the care product in the developmental program.

40. The method of claim 2, wherein the determining a future value comprises:
identifying an abnormality in the landscape architectural object;
prescribing at least one of a care instruction and a care product to address the abnormality; and
adjusting the material cost based on the prescribed at least one of a care instruction and a care product.

41. The method of claim 2, comprising:
adjusting the future value based on a value of property associated with the landscape architectural object and the landscape architectural setting.

42. The method of claim 2, comprising:
adjusting the future value based on a total future value associated with a plurality of landscape architectural objects as included in the landscape architectural setting.

43. The method of claim 2, comprising:
adjusting the future value based on a total future value associated with a plurality of landscape architectural objects of a same object category as included in the landscape architectural setting.

44. The method of claim 2, wherein the determining a future value comprises:
determining a value associated with the landscape architectural object based on an aesthetic contribution of the object to the landscape architectural setting.

45. The method of claim 44, wherein the aesthetic contribution is associated with at least one of a spacing, a mass, an alignment, a color, a lighting, a shading, a texture, and a scent associated with the architectural landscape object.

46. The method of claim 44, wherein the aesthetic contribution is associated with at least one of a unity and variety, a rhythm and balance, an accent and contrast, a scale and proportion, a dimensionality, and a spatiality associated with the landscape architectural setting.

47. The method of claim 2, wherein the determining a future value is associated with at least one of an implementation, a scheme, a plan, and a design of the landscape architectural setting.

48. The method of claim 2, wherein the determining a future value is associated with an existing landscape architectural setting.

49. The method of claim 2, comprising:
determining a present value of the landscape architectural object based on the determined future value of the object.

50. The method of claim 2, wherein the landscape architectural object includes at least one of a natural and a structural object.

51. The method of claim 50, wherein the natural object includes at least one of earth, rock, water, and a planting.

52. The method of claim 51, wherein the water includes at least one of a pond, a waterfall, a stream, and a marsh.

53. The method of claim 51, wherein the planting includes at least one of any in a kingdom of plants.

54. The method of claim 50, wherein the structural object includes at least one of an earthen-structure, an enclosure, a shelter, a specialty building, an engineering structure, an engineering system, a sculptural component, and an outdoor furnishing.

55. The method of claim 54, wherein the earthen-structure includes at least one of a berm, a mound, a slope, a swell, an earthen-planter, an earthen-retaining wall, and a dry creek bed.

56. The method of claim 54, wherein the enclosure structure includes at least one of a fence and a wall.

57. The method of claim 54, wherein the shelter structure includes at least one of a gazebo, a garden house, and a pagoda.

58. The method of claim 54, wherein the specialty building includes at least one of an arbor and a pergola.

59. The method of claim 54, wherein the engineering structure includes at least one of a vehicular way, a pedestrian way, a deck, a patio, a pool, a fountain, a retaining wall, and a planter.

60. The method of claim 54, wherein the engineering system includes at least one of an irrigation system, a lighting system, and a garden railroad system.

61. The method of claim 54, wherein the sculptural component can include at least one of a statue, a sculpture, and an ornament.

62. The method of claim 54, wherein the outdoor furnishing includes at least one of a bench, a glider, and a swing.

63. A method for providing a landscape architecture valuation report, the method comprising:
determining a future value associated with at least one landscape architectural object as included in a landscape architectural setting;
identifying at least one attribute associated with the landscape architectural object; and
presenting in the report the future value and the at least one attribute associated with the landscape architectural object.

64. The method of claim 63, comprising
presenting in the report a developmental program including at least one of a care instruction and a prescription care product associated with a development of each landscape architectural object.

65. The method of claim 64, wherein the prescription care product includes at least one of a nutritional substance, a protective substance, and a device associated with the development of the landscape architectural object.

66. The method of claim 65, wherein the nutritional substance includes at least one of a fertilizer, nitrogen, phosphate, and sulfur.

67. The method of claim 65, wherein the device includes at least one of a pruner, a hose, a shovel, an applicator, a power washer, a lawn mower, structural material, and a spreader.

68. The method of claim 65, wherein the protective substance includes at least one of mulch, a tree wrap, a mildewcide, a stain, a paint, a sealer, and a pesticide.

69. The method of claim 64, wherein the care instruction includes at least one of a prescribed temperature, rainfall amount, sunshine amount, slope, drainage, landscape density, shade-to-sun ratio, soil pH, soil salinity, soil hardness, soil compactness, soil texture, soil color, calcium carbonate (CaCO₃) content, and maintenance associated with the development of the landscape architectural object.

70. The method of claim 64, comprising:
presenting an identity of a source of the prescription care product in the report.

71. The method of claim 64, comprising:
presenting an identity of an implementer of the developmental program in the report.

72. The method of claim 64, comprising:
determining a cost associated with the developmental program; and
presenting the cost associated with the developmental program in the report.

73. The method of claim 72, comprising:
determining an increase in the future value associated with an implementation of the developmental program; and
presenting the increase in the future value in the report.

74. The method of claim 63, comprising:
presenting a coupon associated with at least one of the landscape architectural object and the landscape architectural setting in the report.

75. The method of claim 63, comprising:
presenting an image of the landscape architectural object in the report.

76. The method of claim 63, wherein the attribute associated with the landscape architectural object includes at least one of an identity, a geographic location, a climate, a use, an installed cost, a hardiness, an active growth period, a fall conspicuous, a flower color, a flower conspicuous, a foliage color, a foliage porosity summer, a foliage porosity winter, a foliage texture, a fruit/seed color, a fruit/seed conspicuous, a growth form, a growth rate, a height, a maturity, a spread, a basal width, a container size, a leaf retention, a lifespan, a shape, an orientation, a soil adaptability, an anaerobic capacity, a calcium carbonate (CaCO₃) tolerance, a cold stratification, a drought tolerance, a fire tolerance, a frost tolerance, a hedge tolerance, a moisture use, a PH range, a planting density, a rainfall, a water usage, a root depth, a salinity tolerance, a shade tolerance, a temperature range, a bloom period, and a commercial availability associated with the landscape architectural object.

77. The method of claim 76, wherein the identity includes at least one of a genus, a species, a subspecies, a variety, a form a, a scientific name, a common name, a category, a family, a cultivar, an order, a class and a division associated with the landscape architectural object.

78. The method of claim 63, wherein the future value is based on at least one of a material cost associated with the landscape architectural object and an installation cost associated with an installing of the landscape architectural object in a landscape architectural setting.

79. The method of claim 63, comprising:
categorizing the at least one landscape architectural object into an object type;
wherein the presenting is based on the categorized object type.

80. The method of claim 63, comprising:
gathering an inventory of at least one landscape architectural object included in the landscape architectural setting; and
presenting the inventory in the report.

81. The method of claim 63, comprising:
determining insurance premium information based on the future value of the at least one landscape architectural object; and
presenting the insurance premium information in the report.

82. The method of claim 63, comprising:
identifying at least one attribute associated with the landscape architectural setting; and
presenting the at least one attribute associated with the landscape architectural setting in the report.

83. The method of claim 82, wherein the at least one attribute of the landscape architectural setting includes a geographic location, a temperature, a rainfall amount, a sunshine amount, a slope, a drainage, a landscape density, a shade-to-sun ratio, a soil pH, a soil salinity, a soil hardness, a soil compactness, a soil texture, a soil color, and a calcium carbonate (CaCO₃) content.

84. The method of claim 63, comprising:
gathering information associated with at least one of a user of information included in the report and an owner of the landscape architectural setting; and
presenting the information associated with the least one of a user and an owner in the report.

85. The method of claim 63, wherein the report is provided in connection with at least one of an implementation, a scheme, a plan, and a design of the landscape architectural setting.

86. The method of claim 63, wherein the report is provided in connection with at least one of an appraisal and an inspection of property associated with the landscape architectural object and the landscape architectural setting.

87. A method of insuring landscape architectures, the method comprising:
identifying a landscape architectural object;
determining a future value associated with the landscape architectural object based on at least one of a material cost associated with the landscape architectural object and an installation cost associated with an installing of the landscape architectural object in a landscape architectural setting;
determining a risk-of-loss associated with the landscape architectural object; and
assigning a premium cost to the object based on the determined future value and risk-of-loss.

88. The method of claim 87, wherein the risk-of-loss is based on frequency-of-loss information.

89. The method of claim 88, wherein the frequency-of-loss information includes at least one of disaster, casualty, and replacement frequency-of-loss information.

90. The method of claim 87, wherein the risk-of-loss is based on severity-of-loss information.

91. The method of claim 90, wherein the severity-of-loss information includes at least one of disaster, casualty, and replacement severity-of-loss information.

92. The method of claim 87, comprising:
adjusting the premium cost based on a value of property associated with the landscape architectural object and the landscape architectural setting.

93. The method of claim 87, comprising:
adjusting the premium cost based on a total future value associated with a plurality of landscape architectural objects as included in the landscape architectural setting.

94. The method of claim 87, comprising:
adjusting the premium cost based on a total future value associated with a plurality of landscape architectural objects of a same object category as included in the landscape architectural setting.

95. The method of claim 87, wherein the assigning a premium cost comprises:
adjusting the premium cost based on a comparison to an industry standard premium cost.

96. The method of claim 87, comprising:
identifying a standard for insuring the landscape architectural object;
wherein the premium cost is based on the identified standard for insuring.

97. A method for certifying a landscape architecture valuation, the method comprising:
identifying a landscape architectural object;
identifying a standard for valuing the landscape architectural object;
determining a future value associated with the landscape architectural object based on at least one of a material cost associated with the landscape architectural object and an installation cost associated with an installing of the landscape architectural object in a landscape architectural setting according to the identified standard for valuing the landscape architectural object; and
creating a certified appraisal associated with the landscape architectural object based on the determined future value.

98. The method of claim 97, comprising:
identifying a standard for inspecting the landscape architectural object;
creating a certified inspection report associated with the landscape architectural object based on the identified standard for inspecting; and
adjusting the future value associated with the landscape architectural object based on the certified inspection report.

99. The method of claim 97, comprising:
identifying a standard for insuring the landscape architectural object;
creating a certified insurance arrangement associated with the landscape architectural object based on the determined future value and the identified standard for insuring.

100. The method of claim 97, comprising:
identifying a standard for lending using the landscape architectural object as collateral; and
creating a certified lending arrangement associated with the landscape architectural object based on determined future value and the identified standard for lending.

101. A system for valuing landscape architectures, the system comprising:
a data model including information associated with a landscape architectural object; and
a processor operatively coupled to the data model, the processor including logic configured to determine a future value associated with the landscape architectural object based on at least one of a material cost associated with the landscape architectural object and an installation cost associated with an installing of the landscape architectural object in a landscape architectural setting.

102. The system of claim 101, wherein the processor comprises:
logic configured to determine a growth rate associated with the landscape architectural object based on at least one of an attribute of the landscape architectural object and an attribute of the landscape architectural setting included in the data model.

103. The system of claim 102, wherein the attribute of the landscape architectural object included in the data model includes at least one of a hardiness, a disease susceptibility, an insect damage susceptibility, a height, a maturity, a spread, a basal width, a container size, a lifespan, a soil adaptability, an anaerobic capacity, a pollution tolerance, a drought tolerance, a fire tolerance, a frost tolerance, a precipitation range, a salinity tolerance, a shade tolerance, a drainage capacity, a shade-to-sun capacity, and a temperature tolerance.

104. The system of claim 102, wherein the attribute of the landscape architectural setting included in the data model includes at least one of a geographic location, a climate, an air quality, a pollution amount, a temperature, a rainfall amount, a sunshine amount, an atmospheric pressure, a wind amount, a slope, an altitude, a drainage, a landscape density, a shade-to-sun ratio, a soil pH, a soil salinity, a soil hardness, a soil compactness, a soil texture, a soil color, a calcium carbonate (CaCO₃) content, and a moisture retention factor.

105. The system of claim 101, wherein the processor comprises:
logic configured to determine an environmental trend model based on environmental trend data included in the data model.

106. The system of claim 105, wherein the environmental trend data included in the data model includes at least one of temperature data, pollution data, water availability data, rainfall data, and drought data associated with the landscape architectural setting.

107. The system of claim 101, wherein the processor comprises:
logic configured to determine a size of the landscape architectural object based on the determined growth rate; and
logic configured to determine the material cost associated with the landscape architectural object based on the determined size.

108. The system of claim 101, wherein the processor comprises:
logic configured to determine a depreciation rate associated with the landscape architectural object based on at least one of an attribute of the landscape architectural object and an attribute of the landscape architectural setting.

109. The system of claim 102, wherein the attribute of the landscape architectural object included in the data model includes at least one of a material type, a construction quality, a dimension, and a material finish.

110. The system of claim 102, wherein the attribute of the landscape architectural setting included in the data model includes at least one of a geographic location, a climate, an air quality, a pollution amount, a temperature, a rainfall amount, a sunshine amount, an atmospheric pressure, a wind amount, a slope, an altitude, a drainage, a shade-to-sun ratio, and a soil compactness.

111. The system of claim 101, wherein the processor comprises:
logic configured to determine regional pricing information associated with the landscape architectural object and the installing of the landscape architectural object in the landscape architectural setting based on information included in the data model.

112. The system of claim 111, wherein the processor includes:
logic configured to aggregate pricing information associated with at least one zip code included in the data model.

113. The system of claim 111, wherein the processor comprises:
logic configured to update periodically the regional pricing information based on current regional pricing information associated with the landscape architectural object and the installing of the landscape architectural object in the landscape architectural setting included in the data model.

114. The system of claim 111, wherein the regional pricing information included in the data model includes at least one of retail regional pricing information, wholesale regional pricing information, and industry standard pricing information associated with the landscape architectural object and the installing of the landscape architectural object in the landscape architectural setting.

115. The system of claim 111, wherein the retail regional pricing information included in the data model includes at least one of labor contracting quotes from at least one of industry publications and affiliated labor contractors, and information describing a time and a cost per unit of time associated with the installing of the landscape architectural object in the landscape architectural setting.

116. The system of claim 101, wherein the processor comprises:
logic configured to determine a macro-economic trend model based on macro-economic trend data included in the data model.

117. The system of claim 116, wherein the macro-economic trend data included in the data model includes at least one of “NASDAQ” data, “RUSSELL 2000” data, thirty-year treasury bill data, consumer price index data, “DOW JONES” industrial average data, “STANDARD AND POOR'S” data, gold pricing data, five-year treasury bill data, inflation data, crude oil pricing data, unemployment data, federal reserve data, ten-year treasury bill data, and minimum wage data.

118. The system of claim 101, wherein the processor comprises:
logic configured to determine a property value trend model based on property value trend data included in the data model.

119. The system of claim 118, wherein the property value trend data included in the data model includes at least one of a property sale price, an advertised property price, an insured property value, a property type, a property grade, a lot size, a structure size, and a property tax assessment value associated with the landscape architectural setting.

120. The system of claim 101, wherein the processor comprises:
logic configured to adjust the future value based on a developmental program associated with a development of the landscape architectural object in the landscape architectural setting.

121. The system of claim 101, wherein the processor comprises:
logic configured to adjust the future value based on a prescription care program configured to address an abnormality in at least one of the landscape architectural object and landscape architectural setting.

122. The system of claim 101, wherein the processor comprises:
logic configured to adjust the future value based on a total future value associated with at least one of a plurality of landscape architectural objects and a plurality landscape architectural objects of a same object category as included in the landscape architectural setting.

123. The system of claim 101, wherein the processor comprises:
logic configured to determine a value associated with the landscape architectural object based on an aesthetic contribution of the object to the landscape architectural setting based on aesthetic data included in the data model.

124. The system of claim 123, wherein the aesthetic data included in the data model includes at least one of a spacing, a mass, an alignment, a color, a lighting, a shading, a texture, and a scent associated with the architectural landscape object; and at least one of a unity and variety, a rhythm and balance, an accent and contrast, a scale and proportion, a dimensionality, and a spatiality associated with the landscape architectural setting.

125. The system of claim 101, wherein the processor comprises:
logic configured to determine a present value of the landscape architectural object based on the determined future value of the object.

126. The system of claim 101, wherein the processor comprises:
logic configured to identify at least one attribute associated with the landscape architectural object included in the data model; and
logic configured to present a report including the future value and the at least one attribute associated with the landscape architectural object.

127. The system of claim 126, wherein the processor comprises
logic configured to present in the report a developmental program including at least one of a care instruction and a prescription care product data included in the data model associated with a development of each landscape architectural object.

128. The system of claim 127, wherein the prescription care product data included in the data model includes at least one of a nutritional substance, a protective substance, and a device associated with the development of the landscape architectural object.

129. The system of claim 127, wherein the processor comprises:
logic configured to present an identity of a source of the prescription care product in the report.

130. The system of claim 127, wherein the processor comprises:
logic configured to present an identity of an implementer of the developmental program in the report.

131. The system of claim 127, wherein the processor comprises:
logic configured to determine a cost associated with the developmental program based on information included in the data model; and
logic configured to present the cost associated with the developmental program in the report.

132. The system of claim 127, wherein the processor comprises:
logic configured to determine an increase in the future value associated with an implementation of the developmental program; and
logic configured to present the increase in the future value in the report.

133. The system of claim 126, wherein the processor comprises:
logic configured to present a coupon associated with at least one of the landscape architectural object and the landscape architectural setting in the report.

134. The system of claim 126, wherein the processor comprises:
logic configured to present an image of the landscape architectural object in the report.

135. The system of claim 126, wherein the attribute associated with the landscape architectural object included in the data model includes at least one of an identity, a geographic location, a climate, a use, an installed cost, a hardiness, an active growth period, a fall conspicuous, a flower color, a flower conspicuous, a foliage color, a foliage porosity summer, a foliage porosity winter, a foliage texture, a fruit/seed color, a fruit/seed conspicuous, a growth form, a growth rate, a height, a maturity, a spread, a basal width, a container size, a leaf retention, a lifespan, a shape, an orientation, a soil adaptability, an anaerobic capacity, a calcium carbonate (CaCO₃) tolerance, a cold stratification, a drought tolerance, a fire tolerance, a frost tolerance, a hedge tolerance, a moisture use, a PH range, a planting density, a rainfall, a water usage, a root depth, a salinity tolerance, a shade tolerance, a temperature range, a bloom period, a genus, a species, a subspecies, a variety, a form a, a scientific name, a common name, a category, a family, a cultivar, an order, a class, a division and a commercial availability associated with the landscape architectural object.

136. The system of claim 126, wherein the processor comprises:
logic configured to categorize the at least one landscape architectural object into an object type;
wherein the presenting is based on the categorized object type.

137. The system of claim 126, wherein the processor comprises:
logic configured to gather an inventory of at least one landscape architectural object included in the landscape architectural setting; and
logic configured to present the inventory in the report.

138. The system of claim 126, wherein the processor comprises:
logic configured to determine insurance premium information based on the future value of the at least one landscape architectural object; and
logic configured to present the insurance premium information in the report.

139. The system of claim 126, wherein the processor comprises:
logic configured to identify at least one attribute associated with the landscape architectural setting included in the data model; and
logic configured to present the at least one attribute associated with the landscape architectural setting in the report.

140. The system of claim 139, wherein the at least one attribute of the landscape architectural setting included in the data model includes a geographic location, a temperature, a rainfall amount, a sunshine amount, a slope, a drainage, a landscape density, a shade-to-sun ratio, a soil pH, a soil salinity, a soil hardness, a soil compactness, a soil texture, a soil color, and a calcium carbonate (CaCO₃) content.

141. The system of claim 126, wherein the processor comprises:
logic configured to gather information associated with at least one of a user of information included in the report and an owner of the landscape architectural setting; and
logic configured to present the information associated with the least one of a user and an owner in the report.

142. A computer readable medium containing a computer program for valuing landscape architectures, wherein the computer program comprises executable instructions for:
identifying a landscape architectural object;
determining a growth rate associated with the landscape architectural object;
determining regional pricing information associated with at least one of the landscape architectural object and the installing of the landscape architectural object in the landscape architectural setting;
determining at least one of a material cost associated with the landscape architectural object and an installation cost associated with an installing of the landscape architectural object based on the determined growth rate and regional pricing information; and
determining a future value associated with the landscape architectural object based on at least one of the material cost associated with the landscape architectural object and the installation cost associated with an installing of the landscape architectural object.

143. A computer readable medium containing a computer program for providing a landscape architecture valuation report, wherein the computer program comprises executable instructions for:
determining a future value associated with at least one landscape architectural object as included in a landscape architectural setting;
identifying at least one attribute associated with the landscape architectural object; and
presenting in the report the future value and the at least one attribute associated with the landscape architectural object.

144. A computer readable medium containing a computer program for insuring landscape architectures, wherein the computer program comprises executable instructions for:
identifying a landscape architectural object;
determining a future value associated with the landscape architectural object based on at least one of a material cost associated with the landscape architectural object and an installation cost associated with an installing of the landscape architectural object in a landscape architectural setting;
determining a risk-of-loss associated with the landscape architectural object; and
assigning a premium cost to the object based on the determined future value and risk-of-loss.
